(19) United States
(12) Patent Application Publication
(10) Pub. No.: US 2015/0304118 A1
(43) Pub. Date: Oct. 22, 2015

(54) METHOD FOR PRESELECTING A ROUTER IN AN RPL NETWORK

(71) Applicant: COMMISSARIAT A L'ENERGIE ATOMIQUE ET AUX ENE ALT, Paris (FR)

(72) Inventors: Christophe JANNETEAU, Chaudon (FR); Mounir KELLIL, Massy (FR); Nicolas RIOU, Meylan (FR)

(73) Assignee: COMMISSARIAT A L'ENERGIE ATOMIQUE ET AUX ENE ALT, Paris (FR)

(21) Appl. No.: 14/383,356

(22) PCT Filed: Mar. 5, 2013
(86) PCT No.: PCT/EP13/54316

§ 371 Date: Sep. 5, 2014

(30) Foreign Application Priority Data
Mar. 7, 2012 (FR) 12 52077

(51) Int. Cl. H04L 12/18; H04L 12/761; H04L 12/705; H04L 12/751

(52) U.S. Cl. CPC H04L 12/189; H04L 45/02; H04L 45/16; H04L 45/18

(57) ABSTRACT

A method for preselecting a router in a LLN (Lower power and Lossy Network) network from a plurality of nodes in which each router node transmits to the other router nodes of the LLN network within direct radio range of the router node an announcement message, and, upon receiving the announcement message, each of the other router nodes compares its current status with respect to a router node with the status indicated in the announcement message, and configures its status depending on the comparison so that a single node from among the nodes of the LLN network within direct radio range of the router node transmits to the root node a configuration request MER_Request as a multicast router for data from or intended for the host node.

### TECHNICAL FIELD

The invention is located within the context of multicasts in computer networks with strong constraints in terms of available resources (batteries, memories, computing capabilities, available links, etc.) and more specifically relates to a method for preselecting a router in an LLN (Lower power and Lossy Network) network from among a plurality of nodes which may act as routers of data packets exchanged between a plurality of host nodes, said LLN network including a root node responsible for managing a first association table containing a list of router nodes allowed to transfer multicast packets of the LLN network to a given host node or from a given host node to the LLN network, each router node having a status from among one of the following statuses:
CANDIDAT_MER (Multicast Edge Router), indicating that the router node is a candidate for acting as a single multicast router for a given host node;
PENDING indicating that the router node is waiting to be selected as a single multicast router for a given host node;
MER, indicating that the router node is configured as a single multicast router for a given host node;
NON_MER, indicating that said router node is configured so as not to be a multicast router for said host node.

The invention also relates to a device for applying the method according to the invention and to a program stored in memory on a recording medium including instructions for applying the steps of the method when it is practised on a computer.

### STATE OF THE PRIOR ART

The duplication of data packets exchanged during communications of the multicast type in LLN (Lower power and Lossy Network) type networks has the effect of generating a waste of resources such as bandwidth, computing capacity, memory space and energy reserve which are very limited in this type of networks. This waste may cause significant dysfunction of the network, its premature aging, or even its completely blocking.

This problem occurs when a multicast packet is transmitted/broadcast in a frame of level 2 corresponding to the sublayer for logical link control of the OSI model (OSI pour Open System Interconnection); for example the MAC (Media Access Control) level of the broadcast type, which is often the case in computer networks, including LLN networks.

Within the context of a network of the RPL (Routing Protocol for Low power and Lossy Networks) type, for example the duplicated packets may be from a node which broadcasts multicast data packets without observing the transfer logic of an RPL node, i.e., without transferring the multicast packet in a unicast frame (of level 2) towards one or even several determined neighboring nodes. This happens, if for example the relevant node is within radio range from an RPL network but does not, strictly speaking, belong to this network. This situation corresponds to the case when the node does not have any information on the nodes of the RPL network, or does not use the functionalities of this type of network. Such a node may for example be a node without any battery recovering the energy required for transmitting a message, a command for example, through an outer physical action undergone by the node such as a node of the ZigBee Green Power type (wireless and batteryless switch).

In the case of a multicast source, the latter may send a multicast IP packet on a level 2 frame of the broadcast type which will be received by all the RPL routers within direct radio range from this source. If this is a multicast packet of the multi-hop type, a neighbor to neighbor transmission will be carried out until the packet reaches its final destination. However, if the multicast IP packet emitted by the source is received by several RPL routers within direct radio range of said source, each of these routers will transmit on the network a copy of said packet. This situation is then at the origin of the duplication of said packet in the RPL network since this same packet is simultaneously and independently injected into the RPL routing tree by several nodes. Thus, a node on the path of the packets, which may either be an intermediate router or the final destination of the packets, risks receiving several copies of the same multicast packets, which may generate a number of problems such as overconsumption of the bandwidth of the network or further its premature aging.

The case of a node which is a destination for the packets is similar to the one of the source in terms of effects on the network, except that the purpose of the destination node is to receive multicast packets and not to emit them. To do this, the destination node transmits in a broadcast (of level 2) mode, its requests for adhering to an IP multicast group in an RPL network, for example a request of the MLD report type ([R. Vida et al. <<Multicast Listener Discovery>> Version 2 (MLDv2) for IPv6>>, RFC 3610, June 2004]). In this case, even if the request of the destination node has a local range in the IP sense (link_local scope), it may be taken into account by several RPL routers within direct radio range of the destination node. In this case, any RPL router having received said request, will initiate the construction of a routing path consisting in a branch of a multicast tree going from the RPL network towards the destination node. Therefore, the destination node risks receiving as many copies of a same IP multicast packet as there are RPL routers within its direct range. There again, this duplication of traffic in the RPL network may generate a number of problems such as for example overconsumption of the bandwidth of the network or its premature aging.

Moreover, in dense networks, where the multicast source or receiver are within direct radio range of several RPL routers, several nodes may be simultaneously candidates for acting as a multicast router for a given host node. This is expressed by a significant number of candidate requests to the root node for this purpose. The result of this is also an overconsumption of the bandwidth and a significant processing load of requests by the root node.

The object of the invention is to overcome the drawbacks of the prior art as described above by means of a so-called <<local>> selection method concerning the RPL router nodes within direct radio range of a source or receiver allowing these RPL router nodes to decide which of them will transmit to the root node a MER_Request message in order to be used as a single multicast router for a host node, source or receiver of multicast data, and optionally for a given multicast group. This method aims at reducing the number of RPL nodes which will be candidates for selecting a multicast router for a given host node in the RPL network.

Another object of the invention is to define a local procedure, called a procedure for selecting candidates, allowing automatic selection of the candidate nodes for sending an MER_Request request to the root node, these candidates may be nodes which are not within the direct range of a host (source or receiver).

### DISCUSSION OF THE INVENTION

This object is achieved by means of a method for preselecting a router in an LLN (Lower power and Lossy Network) network from a plurality of nodes which may act as routers for data packets exchanged between a plurality of host nodes, said LLN network including a root node responsible for managing a first association table containing a list of router nodes allowed to transfer multicast packets from the LLN network to a given host node or from a given host node to the LLN network, each router node having a status from among one of the following statuses:

CANDIDAT_MER (Multicast Edge Router), indicating that said router node is a candidate for acting as a single multicast router for a given host node;

PENDING indicating that the router node is waiting to be selected by the root node as a single multicast router for said host node;

MER, indicating that said router node is configured as a single multicast router for said host node;

NON_MER, indicating that said router node is configured so as to not be a multicast router for said host node.

The method according to the invention includes the following steps:
upon receiving by a given router node of a multicast data packet or of a subscription request to a multicast group (e.g. a message of the MLD (Multicast Listener Discovery) Report type) from a given host node, said router node transmits to the other router nodes of the LLN network within its direct radio range, an announcement message including its status with respect to the host node and the address of said host node.
upon receiving said announcement message, each of said other router nodes compares its current status with respect to said host node with the status indicated in the announcement message, and configures its status depending on said comparison so that a single node from among the nodes of the LLN network within direct radio range of said router node transmits to the root node a configuration request MER_Request as a multi-cast router for the data from or to said given host node, and,
upon receiving said request MER_Request, the root node grants the MER status for said host node to the first router node having transmitted an MER_Request.

According to another characteristic of the method of the invention, each router node stores in memory in a second association table routing information in the following fields:
a field <<host address>> intended to contain the address of the host node;
an optional field <<host type>> intended to contain the type of said host node from among one of the two following types, source or receiver;
an optional field <<multicast IP address>> intended to contain the address of a multicast group to which belongs the host node;
a <<status>> field intended to contain the status of the router node with respect to said host node, and which may assume one of the four following values: CANDIDAT_MER, PENDING, MER and NON_MER;
a field <<Lifetime_table_entry>> intended to contain a lifetime of the entry associated with the host node in said second association table, i.e. a lifetime of the status of the router node with respect to said host node;
a field <<Lifetime_status>> intended to contain a wait time of a router in a CANDIDAT_MER mode before passing to the PENDING mode and sending a MER_Request message to the root node.

In the continuation of the description, any optional field of the MER_Request/MER_Reply messages and of the tables of association will be designated by [X], wherein X represents the name of the optional field. These optional fields are: the type of the host node and the multicast IP address.

According to another characteristic of the invention, when a router node receives said announcement message, it first of all checks in said second association table whether one of its entries corresponds to the fields: host address, [host type], and the [multicast IP address] of the received announcement message, and if the check does not return any entry, said router node will ignore the received announcement message.

If an entry corresponding to the aforementioned verification criterion was found, then the continuation of the operations at said router node will take place depending on the value of the status of the entry found (CANDIDAT_MER, PENDING, MER, NON_MER) and on the value of the indicated status in said announcement message.

Thus, if the announcement message contains a status CANDIDAT_MER and if the entry found in said second association table has a CANDIDAT_MER status, the router node compares its address with that of the router node which transmitted the announcement message, and, retains its CANDIDAT_MER status if its address is less than that of the router node which transmitted the announcement message, or sets the status associated with the entry found to NON_MER if its address is greater than the address of the router node which transmitted the announcement message.

Further, if the announcement message contains a CANDIDAT_MER status and said second association table of the router node having received the announcement message contains an entry corresponding to the fields: host address, [host type], and [multicast IP address] contained in the received announcement message, and, if such an entry includes a PENDING status or a NON_MER status, or a MER status for said router node with respect to the host node identified in the announcement message, the latter ignores the received announcement message.

Let us note that, optionally if said entry includes a MER status, said router node may reply to the router node having sent said announcement message with another announcement message containing a MER status associated with the fields: host address, [host type], and [multicast IP address] of said entry.

If the announcement message contains a MER status and the second association table of the router node having received the announcement message contains an entry corresponding to the fields: host address, [host type], and [multicast IP address] contained in the received announcement message, and,
if such an entry indicates a NON_MER status, said router node replaces the value of the field lifetime_table_entry associated with the entry found, with the one indicated in the received message so as to synchronize the value of the field [lifetime_table_entry] at all the router nodes having the entry found,
if such an entry indicates a CANDIDAT_MER status, said router node replaces the value of the field lifetime_table_entry associated with the entry found with the one indicated in the received message and changes the status of the entry to NON_MER.
if such an entry indicates a PENDING status, said router node replaces the value of the field lifetime_table_entry associated with the entry found with the one indicated in the received message and changes the status of the entry to NON_MER.

Alternatively, said router node may ignore the received message.

If the announcement message contains a NON_MER status and the second association table of the router node having received the announcement message contains an entry corresponding to the fields: host address, [host type], and [multicast IP address] contained in the received announcement message, and, if such an entry indicates a MER status, said router node ignores the received message,
if such an entry indicates a NON_MER status, said router node replaces the value of the field lifetime_table_entry associated with the entry found, with the one indicated in the received message,
if such an entry indicates a CANDIDAT_MER status, said router node replaces the value of the field lifetime_table_entry associated with the entry found with the one indicated in the received message and changes the status of the entry to NON_MER.
if such an entry indicates a PENDING status, said router node replaces the value of the field lifetime_table_entry associated with the entry found with the one indicated in the received message and changes the status of the entry to NON_MER. Alternatively, said router node may ignore the received message.

According to another characteristic of the method of the invention, when a router node receives a request for subscription to a multicast group (e.g. a message of the MLD Report type) from a host node of the receiver type, said router node consults said second association table in order to check whether it has already received a same subscription request (e.g., a same MLD Report message); and, if this is the case, the subscription request message (e.g., the MLD Report message) is ignored by said router mode, otherwise, the router node generates a new entry in its second association table containing the fields: host IP address, [host type=receiver], [multicast IP address] inferred from the received subscription request (e.g. from the MLD Report message), sets its status corresponding to the added entry to CANDIDAT_MER, associates this status to a field lifetime_status and to a field lifetime_table_entry each containing a non-zero value, and then broadcasts, in multicast mode, with a local range, an announcement message including the CANDIDAT_MER status as well as the fields: host IP address, [host type=receiver], [multicast IP address].

And, upon receiving a reply message MER_Reply transmitted by the root node and including a NON_MER status, the router node having received the request for subscription to a multicast group (e.g., the MLD Report message) checks whether there exists in said second association table a host node concerned by the received reply message MER_Reply, and if this is the case, sets its status with respect to the relevant host node to NON_MER, and replaces the value of the field lifetime_table_entry with the one indicated in the received message MER_Reply,

Let us note that optionally the router node having received the MER_Reply message transmitted by the root node and including a NON_MER status may also broadcast, in a multicast mode, with a local range, an announcement message including the NON_MER status as well as the fields: host IP address, [host type=receiver], [multicast IP address] so as to allow the router nodes within direct radio range and having an entry corresponding to the fields: host IP address, [host type=receiver], [multicast IP address] marked with the NON_MER, CANDIDAT_MER or PENDING status to update the value of the field lifetime_table_entry of this entry on the basis of the one which is indicated in the announcement message and to set the status of this entry to NON_MER.

In the case when the router node receives a a reply message MER_Reply from the root node including a MER status, said router node checks whether there exists in the second association table a host node concerned by the received MER_Reply message, if this is the case, it sets its status with respect to the relevant host node to MER, and, replaces the lifetime of its status with respect to said host node with the one indicated in the received MER_Reply message (i.e., replaces the value of the field lifetime_table_entry with the one indicated in the received MER_Reply message), establishes a multicast branch in the network going towards said host node, and, broadcasts in a multicast mode with local range, an announcement message including the MER status as well as the fields: host IP address, [host type=receiver], [multicast IP address] so as to allow the router nodes within direct radio range and having an entry corresponding to the fields: host IP address, [host type=receiver] and [multicast IP address] marked with the NON_MER, CANDIDAT_MER or PENDING status to update the value of the field lifetime_table_entry of this entry on the basis of the one which is indicated in the announcement message and to set the status of this entry to NON_MER.

In an exemplary embodiment, the announcement transmitted by the router node is implemented through a message of the DIO type of the RPL protocol (DODAG Information Object).

In the case when a router node receives a multicast data packet transmitted by a router node of the source type, its consults said second association table in order to check whether one of its entries corresponds to the fields: host IP address, [host type=source] and [multicast IP address] inferred from the received multicast packet, and that, if this is the case, the router node checks the status associated with the entry found. If this status is CANDIDAT_MER, the router node having received the multicast data packet broadcasts in a multicast mode with local range an announcement message comprising the CANDIDAT_MER status as well as the fields: host IP address, [host type=source] and [multicast IP address].

If said status is PENDING, said router node stores in memory the received multicast data packet if its memory allows this.

If the status associated with the entry found is MER, the router node transfers the received packet into the multicast tree; and, if said status is NON_MER, the router node ignores the received multicast packet.

In the case when no entry of the second association table corresponds to the fields: host IP address, [host type=source] and [multicast IP address] inferred from the received multicast packet, the router node generates a new entry in its second association table containing said fields: host IP address, [host type=source], [multicast IP address], sets its status corresponding to the added entry, to CANDIDAT_MER, associates this status with a field [lifetime_status] and a field lifetime_table_entry each containing a non-zero value, and then, broadcasts, in a multicast mode with a local range, and announcement message including the CANDIDAT_MER status as well as the fields: host IP address, [host type=source], [multicast IP address].

Let us note that said router node also stores in memory the received multicast data packet if its memory allows this.

And, upon receiving by the router node a reply message MER_Reply transmitted by the root node including a NON_MER status, said router node checks whether there exists in its association table a host node concerned by the received reply message MER_Reply.

If this is the case, said router node sets its status with respect to the relevant host node to NON_MER, replaces the value of the field lifetime_table_entry with the one indicated in the received message MER_Reply and suppresses from its memory any multicast data packet, associated with said entry stored previously.

Let us note that optionally the router node which has just received the message MER_Reply transmitted by the root node and including a NON_MER status, may also broadcast, in multicast mode with local range, an announcement message including the NON_MER status as well as the fields: host IP address, [host type=source], [multicast IP address], so as to allow the router nodes within direct radio range and having an entry corresponding to the fields: host IP address, [host type=source] and [multicast IP address], marked with the NON_MER, CANDIDAT_MER or PENDING status, to update the value of the field lifetime_table_entry of this entry on the basis of the one which is indicated in the announcement message and to set the status of this entry to NON_MER.

On the other hand, upon receiving by the router node a reply message MER_Reply transmitted by the root node including an MER status, said router node checks whether there exists in the second association table a host mode concerned by the received MER_Reply.

If this is the case, said router node sets its status with respect to the relevant host node to MER, replaces the lifetime of its status with respect to the relevant host node with the one indicated in the received message MER_Reply, and then, broadcasts, in a multicast mode with a local range, an announcement message including the MER status as well as the fields: host IP address, [host type=source], [multicast IP address], so as to allow the router nodes within direct radio range and having an entry corresponding to the fields: host IP address, [host type=source] and [multicast IP address], marked with NON_MER, CANDIDAT_MER or PENDING status so as to update the value of the field lifetime_table_entry of this entry on the basis of the one which is indicated in the announcement message and to set the status of this entry to NON_MER.

Further, the router node having received the message MER_Reply configuring it with the MER status for said entry in its second association table may transmit on the network any multicast data packet, associated with said entry, stored previously as well as any future received multicast data packet corresponding to said entry.

Generally, if at the router node, the status associated with a given entry corresponding to the fields: host IP address, [host type=source], [multicast IP address], is CANDIDAT_MER and if the time period indicated in the field lifetime_status associated with this entry expires, said router node passes to the status of PENDING for said entry and transmits to the root node a MER_Request message.

Let us note that if the value of the field lifetime_table_entry associated with the given entry corresponding to the fields: host IP address, [host type=source], [multicast IP address], expires, said router suppresses said entry from its association table.

In a second alternative, it is possible to make a preselection of a subset of router nodes in the LLN (Lower power and Lossy Network) network from a set of nodes capable of acting as routers for data packets exchanged between a plurality of host nodes, said LLN network including a root node responsible for managing a first table containing a list of router nodes allowed to transfer multicast packets from the LLN network to a given host node or from a given host node to the LLN network.

In this case, the two states are associated with a router node:
CANDIDAT_MER (Multicast Edge Router), indicating that said router node is a candidate for acting as a single router for a given host node;
NON_CANDIDAT_MER (Multicast Edge Router), indicating that said the router node is not a candidate for acting as a single router for a given host node.

In this alternative, each router node transmits to the other router nodes of the LLN network within direct radio range of said host node an announcement message including a piece of information having a value on the basis of which the configuration of the router nodes will be conducted as CANDIDAT_MER or NON_CANDIDAT_MER, said piece of information may be contained in the data field of the announcement message (e.g. a given value) or else in a header of the announcement message (e.g. the MAC address or the source IP address of the router node transmitting the announcement).

Upon receiving said announcement message, each of said other router nodes compares the value of its own information (e.g. MAC address or IP address or any other piece of information used for configuring the statuses CANDIDAT_MER/NON_CANDIDAT_MER of a router node) with the one contained in the announcement message, and, if the value of the piece of information contained in the announcement message is less than the value of the piece of information of the router node having received said announcement message, then the latter puts itself into the NON_CANDIDAT_MER state, otherwise, the router node having received said announcement message remains in the CANDIDAT_MER state.

It should be noted that this preselection is not necessarily conditioned by a router node receiving a request for subscription to a multicast group (e.g., an MLD report message) or a multicast message of a given host (receiver or source). In particular according to this second alternative, the preselected MER candidate (i.e. in the CANDIDAT_MER state) may potentially not be in direct range of the host node (receiver or source) which it will serve.

In this second alternative, the source address (e.g. the MAC address or IP address) of the announcement messages (e.g. DIO messages of the RPL protocol) exchanged between the RPL routers in order to allow each router of the RPL network to decide whether it has the right to be a candidate router (i.e. in the CANDIDAT_MER state), and therefore to subsequently contact the root node via MER_Request messages in order to determine if it will be configured by the latter as a single multicast router (i.e. with the MER status) with respect to a given host node.

According to a first characteristic of the second alternative of the invention, each router node having a NON_CANDIDAT_MER status includes a transfer table with which the exchanges of multicast packets may be managed between a router node and a host node, said transfer table including the following fields:
the field <<host address>> intended to contain the address of the host node;
the optional field [host type] intended to contain the type of said host node from one of the two following types, source or receiver;
the optional field [multicast IP address] intended to contain the address of a multicast group to which belongs the host node;
the field <<MAC_x address>>: intended to contain the MAC address of the node from which was received the multicast packet or the MLD report message;
the field <<MAC_y address>> intended to contain the MAC address of the CANDIDAT_{—} MER candidate (non-applicable if the current RPL router is itself a CANDIDAT_MER candidate);
the field Lifetime_table_entry intended to contain a lifetime of the entry associated with the host node in said transfer table.

In the continuation of the description, any optional field of the transfer table will be designated by [X] wherein X represents the name of the optional field. These optional fields are: the host node type and the multicast IP address.

According to another characteristic of the second alternative, each router node includes a table of announcements containing the neighboring routers from which it has received an announcement message, so that every time a NON_CANDIDAT_MER router node receives an announcement message from a new router node which is not already listed in its table of announcements, said NON_CANDIDAT_MER router adds the MAC address of said new router node into its table of announcements, compares the MAC address of the new router node with the MAC address of the current CANDIDAT_MER router node indicated in its table of announcements, and if the IP address of the new router node is less than the one of the current CANDIDAT_{—} MER node, said NON_CANDIDAT_MER router node considers that it is the new router node which is its new CANDIDAT_{—} MER candidate and accordingly updates its table of announcements.

According to another characteristic of this second alternative, when a router node receives a request for subscription to a multicast group (e.g. a message of the MLD report type) from a host node of the receiver type, it consults its second association table in order to check whether it has already received a same subscription request and,
if this is the case, the request (e.g., the MLD report message) is ignored,
otherwise, said router node:
   generates a new entry in its transfer table containing the fields: host IP address, [host type=receiver], [multicast IP address] inferred from the received subscription request (e.g. from the MLD report message),
   associates withis entry the field <<MAC_x address>> which contains the MAC address of the node from which was received the subscription request (e.g. MLD Report message)
   associates with this entry a field lifetime_table_entry containing a non-zero value, and,
stores in memory the message received in the subscription request if it is in the CANDIDAT_MER state and if its memory allows this, translates this message into a MER_Request message, and then transmits said MER_Request message to the root node; on the other hand, if it is in the NON_CANDIDAT_MER state, it transfers said message to the CANDIDAT_MER node indicated in its announcement table.
   When a router node receives a multicast data packet transmitted by a host node of the source type, it consults its transfer table in order to check whether one of its entries corresponds to the fields: host address, [host type=source], and [multicast IP address], inferred from the received multicast packet, and,
if this is not the case, said router node:
generates a new entry in its transfer table containing the fields: host IP address, [host type=source], [multicast IP address] inferred from the received multicast packet, associates with the added entry a field <<MAC_x address>> which contains the MAC address of the node from which was received the multicast packet and a field lifetime_table_entry containing a non-zero value, and, stores in memory the received data packet, if it is of the CANDIDAT_MER type and if its memory allows this, and transmits a MER_Request message to the root node;
or, transfers the received multicast packet to the CANDIDAT_MER router node indicated in its table of announcements if it is of the NON CANDIDAT_MER type.

The first alternative of the method according to the invention is applied by a device in which each router node is adapted for transmitting to the other router nodes of the LLN network within direct radio range of said host node, an announcement message including its status with respect to a host node and the address of said given host node and, each of said other router nodes is adapted for comparing its status with respect to said given host node with the status indicated in the announcement message, and for configuring its status according to said comparison so that a single node from among the nodes of the LLN network within direct radio range of said host node transmits to the root node a configuration request MER_Request as a multicast router for said given host node; said root node being adapted for granting the MER status for the given host node to the first router node having transmitted to it an MER_Request request.

The second alternative of the method according to the invention is applied by a device in which each router node is adapted for transmitting to the other router nodes of the LLN network within its direct radio range an announcement message including a piece of information (e.g. the MAC address or the source IP address of the router node transmitting the announcement or any other piece of information) having a value on the basis of which the configuration of the router nodes will be conducted, as CANDIDAT_MER or NON_CANDIDAT_MER, and each of said other router nodes is adapted for comparing the value of its own information (e.g. MAC address or IP address or any other information used for configuring the CANDIDAT_MER/NON_CANDIDAT_MER states of a router node) with the one contained in the announcement message, so that, if the value of the information contained in the announcement message is less than the value of the information of the router node having received said announcement message, then the latter is put in the NON_CANDIDAT_MER state, otherwise it remains in the CANDIDAT_MER state.

The method according to the invention is implemented by a computer program stored in memory on a recording medium and including instructions for carrying out the steps of the first alternative or of the second alternative when it is executed on a computer.

### SHORT DESCRIPTION OF THE DRAWINGS

Other features and advantages of the invention will become apparent from the description which follows, taken as a non-limiting example with reference to the appended figures wherein:

FIG. 1 illustrates the exchange sequence of messages between the RPL nodes, host nodes sources of data packets, and the root node for selecting a multicast router in an RPL network according to the invention;

FIG. 2 illustrates the exchange sequence of messages between RPL nodes, host nodes intended to receive data packets, and the root node for selecting a multicast router in an RPL network according to the invention.

FIG. 3 schematically illustrates the steps for preselecting a router node in a particular alternative of the method according to the invention.

### DETAILED DISCUSSION OF PARTICULAR EMBODIMENTS

The invention will be described when it is applied in an LLN (Lower power and Lossy Network) network including a plurality of RPL (Routing Protocol for LLN) nodes respectively bearing the references 2 and 3 and a root node 4 having a global view on these RPL nodes. The root node 4 includes a first table, a so-called association table, intended to store in memory associations between at least one of the host nodes respectively bearing references 6 and 8 of a multicast group and one of the RPL nodes. A host node may either be the source or destination of the data packets exchanged through the network.

In the continuation of the description, identical references will designate elements fulfilling identical functions in the different figures. A host node source of data packets will be designated by the term of source 6, and a host node destination of data packets will be designated by the term of receiver 8.

For more clarity, the LLN network to which reference will be made in the continuation of this description only includes two router nodes 2 and 3 within direct range of the host nodes 6 and 8. However the method according to the invention also applies in the case when the network includes more than two RPL nodes.

The configuration of an RPL node is achieved by exchanging configuration messages MER_Request/MER_Reply between the root node 4 and each RPL node having requested to be used as a multicast router with respect to a given host node.

The selected RPL node is also called a multicast router on the edge of the network or an MER (Multicast Edge Router) router for a source or a receiver.

In the case when the host node is a source, the MER will be in charge of intercepting multicast packets from the source and transmitting them in the RPL multicast broadcasting tree.

In the case when the host node is a receiver, the MER will be responsible for intercepting the multicast adhesion requests of this receiver, such as for example a request of the MLD report type (Multicast Listener Discovery type as described in [R. Vida et al. <<Multicast Listener Discovery Version 2 (MLDv2) for IPv6>>, RFC 3610, June 2004]) and for triggering the creation of a multicast routing branch in the RPL network for this group, and for transmitting the multicast packets received via the multicast routing branch, to the receiver host node.

In a particular embodiment of the invention, the exchange of MER_Request/MER_Reply messages is implemented through an extension of the DAO/DAO_ACK exchange of the RPL protocol. The DAO (Destination Advertisement Object) message of the RPL protocol is traditionally used by RPL nodes for adding or suppressing a branch (an IP path) of the RPL network. The DAO_ACK message is sent from the root node 4 to the RPL node 8 in response to a DAO message.

Let us note that each RPL node may have one of the following statuses:
CANDIDAT_MER (Multicast Edge Router), indicating that the router node is a candidate for acting as a single multicast router for a given host node;
PENDING indicating that the router node (2, 3) is waiting to be selected by the root node as a single multicast router for said host node,
MER, indicating that said router node is configured as a single multicast router for said host node;
NON_MER, indicating that said router node is configured so as not to be a multicast router for said host node.

The status of an RPL node is written down in a second association table which will further contain the following fields:
host address: IP address of a multicast source or receiver;
host type: optional field specifying the type of the host, where the type may be <<source>> or <<receiver>>;
multicast address: optional field specifying the address of the multicast group associated with the source or the receiver;
Lifetime/usefulness duration: lifetime of the entry associated with the host;
Status: CANDIDAT_MER, PENDING, MER, or NON_MER.

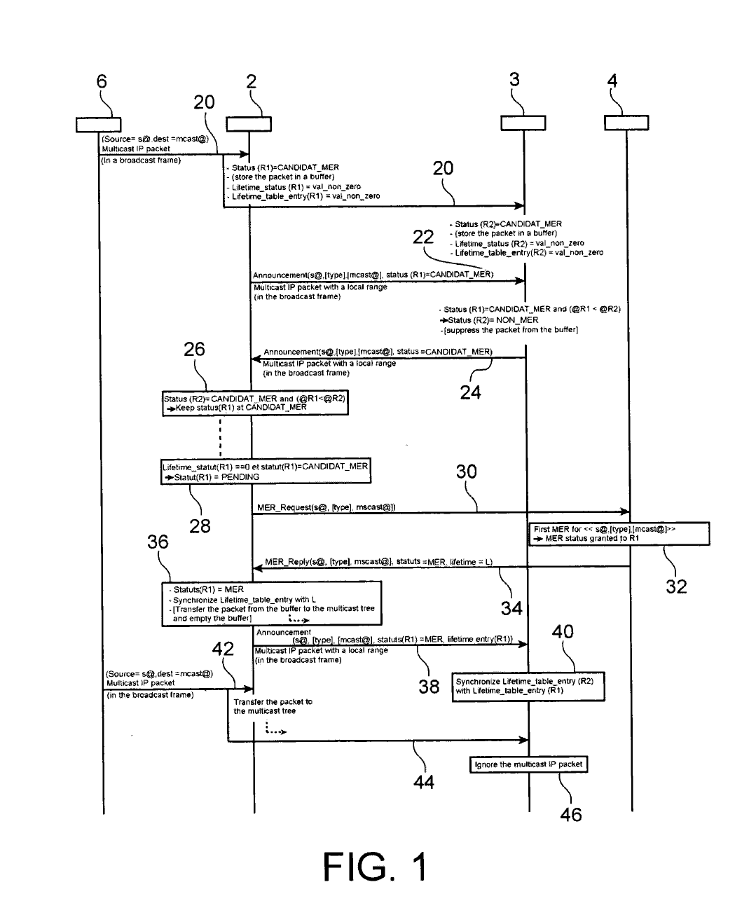

FIG. 1 illustrates the exchanges of messages between the root node 4 and two RPL nodes 2 and 3 for selecting a MER from among both of these nodes for the source 6.

In step 20, the source 6 broadcasts a multicast data packet including, in addition to the useful data, a header indicating the address of the source @S and the multicast address mcast@ of the group to which belongs the destination node of the data packet.

Upon receiving the broadcast packet, each of the RPL nodes 2 and 3 determines that it does not have an entry in its so-called second association table corresponding to the received message and thus generates a new entry for said host node (by indicating therein the address of the host and optionally the type of the host and the multicast address), assigns the status CANDIDAT_MER to this entry, assigns nonzero values respectively to the Lifetime_status and Lifetime_table_entry fields, and stores the received multicast packet if its available memory allows this. Each of the RPL nodes 2 and 3 also generates an announcement message including its status with respect to the source 6 and the address of said host node (i.e. CANDIDAT_MER).

In step 22 (respectively 24), the RPL node 2 (respectively 3) transmits the generated announcement message to the RPL node 3 (respectively 2).

In step 26, the RPL node 2 checks whether the status of the RPL node 3 indicated in the announcement message is CANDIDAT_MER, compares its address with that of the RPL node 3, and, retains its status CANDIDAT_MER if its address is less than that of the RPL node 3.

In step 27, the RPL node 3 checks whether the status of the RPL node 2 indicated in the announcement message is CANDIDAT_MER, compares its address with that of the RPL node 2, and, changes its status to NON_MER, and empties from its memory the stored multicast data packet(s), if its address is greater than that of the RPL node 2.

In step 28, the Lifetime_status field of said entry of the association table of the RPL node 2 expires and the RPL node 2 assigns a value PENDING to its status for said entry.

In step 30, the RPL node 2 transmits to the root node a request MER_Request including the address of the source 6 S@, and optionally the type of the source 6([type=source]) and the address of the multicast group of the destination node of the data packet ([mcast@]).

In step 32, the root node 4 checks whether the RPL node 2 is the first node having transmitted an MER_Request resquest, and if yes, assigns the status MER to this node and transmits to it (step 34) a response MER_Reply including said status MER, the address of the source 6 S@, and optionally the type of source 6([type=source]) and the address of the multicast group of the destination node of the data packet ([mcast@]), as well as a non-zero value for the field Lifetime_table_entry of the RPL node 2 with respect to the source 6.

In step 36, the selected RPL node 2 sets its status with respect to the source to MER, and, replaces the value of the lifetime_table_entry field with the one indicated in the received message MER_Reply, transfers the received multicast data packet(s) from the source 6 to the multicast tree, and then empties its memory.

In step 38, the RPL node 2 broadcasts, in multicast mode with a local range, an announcement message including the status MER as well as the field, IP address of the host, and optionally the fields [host type=source] and [multicast IP address], so as to allow the RPL node 3 to update the value of the [lifetime_table_entry] field of this entry on the basis of the one which is indicated in the announcement message.

In step 40, the RPL node 3 carries out the updating of the value of the [lifetime_table_entry] field.

Upon receiving a new multicast data packet from the source 6 (step 42) the RPL node 2 automatically transfers (step 44) the data packet to the multicast tree, while the RPL node 3 ignores this new packet (step 46).

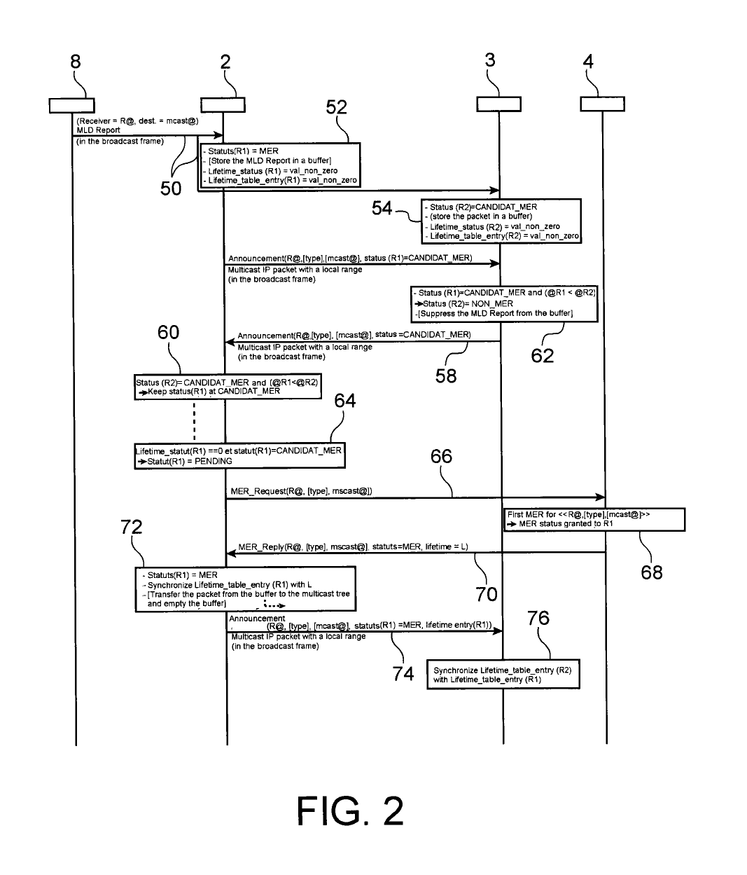

FIG. 2 illustrates the exchanges of messages between the root node 4 and two RPL nodes 2 and 3 for selecting a MER for the receiver 8 from among both of these nodes.

In step 50, the receiver 8 broadcasts a message for adhesion to a multicast group (e.g., a message of the MLD report type) including the address of the receiver 8 and the IP address mcast@ of the multicast group to which belongs the addressee 8.

Upon receiving the message for adhesion to a multicast group (e.g. an MLD message), the RPL node 2 (respectively RPL node 3) determines (step 52) (respectively 54) that it does not have an entry in its so-called second association table corresponding to the received message and thus generates a new entry for said host node (by indicating therein the address of the host and optionally the type of the host (receiver) and the multicast address), assigns the status CANDIDAT_MER to this entry, respectively assigns non-zero values to the Lifetime_status and Lifetime_table_entry fields, and stores the received adhesion message if its available memory allows this. Each of the RPL nodes 2 and 3 thus generates an announcement message including its status with respect to the addressee 8 and the address of said host node 8 (i.e. CANDIDAT_MER).

In step 56 (respectively 58), the RPL node 2 (respectively RPL node 3) transmits the generated announcement message to the RPL node 3 (respectively 2).

In step 60 (respectively 62), the RPL node 2 (respectively RPL node 3) checks the status of the RPL node 3 (respectively RPL node 2) indicated in the announcement message, compares its address with that of the RPL node 3 (respectively RPL node 2) and, retains its status CANDIDAT_MER if its address is less than that of the RPL node 3 (respectively RPL node 2) and if the status of the RPL node 3 is CANDIDAT_MER.

In the example illustrated by FIG. 2, the address @R1 of the RPL node 2 is less than that of the RPL node 3. In this case, the latter sets its status to NON_MER, while the RPL node 2 keeps its status CANDIDAT_MER.

In step 64, the Lifetime_status field of said entry of the association table of the RPL node 2 expires and the RPL node 2 assigns a value PENDING to its status for said entry.

In step 66, the RPL node 2 transmits to the root node 4 a request MER_Request including the address of the addressee 8, and optionally the type of this addressee and the address of the multicast group to which belongs this addressee.

In step 68, the root node checks whether the RPL node 2 is the first node having transmitted an MER_Request request, and if this is the case, grants the MER status to this node and transmits to it (step 70) a response MER_Reply including said MER status, the address of the addressee 8, and optionally the type of this addressee 8 and the address of the multicast group to which belongs this addressee, as well as a non-zero value for the Lifetime_table_entry field of the RPL node 2 with respect to the addressee 8.

In step 72, the selected RPL node 2 sets its status to MER, replaces the value of the lifetime_table_entry field with the one indicated in the received MER_Reply message, and creates a branch of the multicast tree, and then empties its memory.

In step 74, the RPL node 2 broadcasts, in multicast mode with a local range, an announcement message including the status MER, the address of the addressee 8, and optionally the type of the addressee 8 and the multicast IP address of the group to which belongs this addressee 8, as well as the lifetime of the entry (lifetime_table_entry) so as to allow the RPL node 3 to update the value of the lifetime_table_entry field on the basis of the one which is indicated in the announcement message transmitted by the RPL node 2. In step 76, the RPL node 3 carries out the updating of the value of the lifetime_table_entry field.

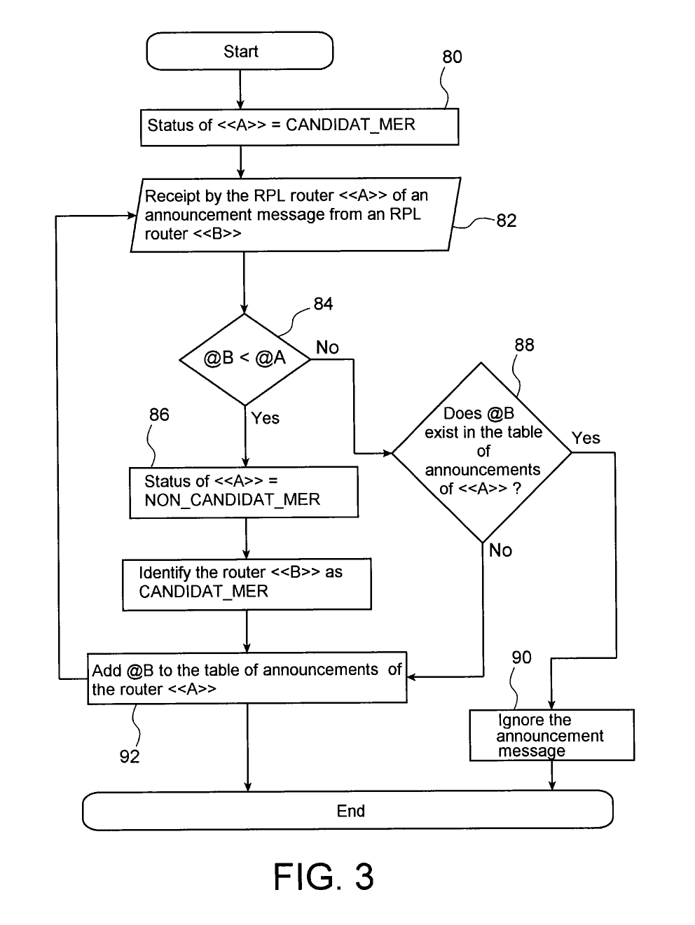

FIG. 3 illustrates the steps of a second alternative of the invention with which it is possible to carry out a preselection of a subset of router nodes having a status from among one of the following statuses, CANDIDAT_MER or NON_CANDIDAT_MER. In this alternative, any RPL node (CANDIDAT_MER or NON_CANDIDAT_MER) stores in its memory the MAC address of the node from which it has received a new multicast packet or a new MLD report. Further, any NON_CANDIDAT_MER router stores in its memory the MAC address of its CANDIDAT_MER router. With this MAC address storage, it is possible to transfer the multicast packets, in unicast level 2 mode, from the source to the CANDIDAT_MER and from the CANDIDAT_MER to the receiver without any risk of duplicating the multicast packets. Further, each NON_CANDIDAT_MER RPL router is assumed to manage a specific table, called a transfer table, allowing transfer of the multicast packets from the MER to the receiver and filtration and transfer of the multicast packets going from the source to the MER. The transfer table at an RPL router contains the following elements:
host address: IP address of a multicast source or receiver,
host type: optional field specifying the type of the host, where the type may be <<source>> or <<receiver>>,
multicast address: optional field specifying the address of the multicast group associated with the source or the receiver,
MAC_x address: MAC address of the node from which was received the multicast packet or the MLD report,
MAC_y address: MAC address of the CANDIDAT_MER (non-applicable if the current RPL router is itself a CANDIDAT_MER),
Lifetime/useful duration: lifetime of the entry associated with the host (e.g. instant when the entry expires).

Further, each RPL node includes a table of announcements containing the neighboring routers from which it has received an announcement message so that each time a NON_CANDIDAT_MER router receives an announcement message from a new router which is not in its table of announcements, said NON_CANDIDAT_MER router adds the MAC address of said new router into said table of announcements.

Thus, when an RPL node called A is reset, it sets its status to <<CANDIDAT_MER>> (step 80) and remains in this state until its status becomes obsolete under certain conditions mentioned hereafter.

When the RPL node A then receives (step 82) an announcement message such as for example a DIO message of the RPL protocol transmitted in a multicast mode with a local range by another RPL router called router B, said router A compares (step 84) its address @A with the address @B of the RPL router B.

If @B<@A, then the router <<A>> puts itself in the NON_CANDIDAT_MER state (step 86) and adds the address @B into its table of announcements by indicating that the router B is CANDIDAT_MER from the point of view of the router A (step 87). In the opposite case, the router A remains in the CANDIDAT_MER state.

If @A<@B, in step 88, the router A checks whether @B already exists in its table of announcements.

If yes, the router A ignores the announcements transmitted by the router B (step 90).

Otherwise, the router A adds the address @B in its table of announcements (step 92).

Thus, by using the source address of the announcement messages exchanged between the RPL routers, each router of the RPL network may decide whether it has the right to be a candidate router (and therefore contacting the root node for this purpose via MER_Request messages).

It should be noted that in this alternative, the CANDIDAT_MER router is not always within the direct radio range of the source.

The method according to the invention applies both in the context of computer/telecommunications networks with low resources (Lower power and Lossy Networks: LLNs), for example networks with wireless sensors (Wireless Sensor Networks), as well as in multicast IP telecommunications networks by:
defining a mechanism for message exchange in the RPL network between a set of routers and a root node; the exchange giving the possibility to the root node of designating a multicast router to be used as a multicast source or as a multicast receiver (i.e. accept/transfer a multicast packet from a multicast source or send a multicast packet to a multicast receiver);
defining a first association table in the root node and a second association table in each RPL node, transfer and announcement tables which associate a selected multicast router (MER) with one or more multicast groups as well as one or more sources and/or receivers, and
defining functionalities for managing said association tables (addition/suppression of entries in the association table) at the root node.
defining functionalities specifying the conditions for selecting a multicast router (MER) at the root node;
defining functionalities specifying the conditions for selecting a multicast router (MER) at the multicast routers.

It is important to note that the present invention applies regardless of the method for routing the multicast traffic used in the RPL network; in particular whether this is the so-called <<multicast storing>> mode as defined by the RPL specification or further the so-called <<multicast non-storing>> mode defined in [C. Janneteau, M. Kellil, BD12830 <<Procédé de routage d'un flux en mode non-stockage>>, French patent application filed on Jul. 11, 2011 under no. 11 56273].

1-21. (canceled)

22. A method for preselecting a router in an LLN (Lower power and Lossy channel Network) network from a plurality of nodes which may act as routers of data packets exchanged between a plurality of host nodes, said LLN network including a root node responsible for managing a first association table containing a list of router nodes allowed to transfer multicast packets of the LLN network to a given host node from a given host node to the LLN network, each router node having a status from among one of the following statuses:
CANDIDAT_MER (Multicast Edge Router), indicating that said router node is a candidate for acting as a single multicast router for a given host node;
PENDING, indicating that the router node is waiting to be selected by the root node as a single multicast router for said host node;
MER, indicating that said router node is configured as a single multicast router for said host node;
NON_MER, indicating that said router node is configured so as not to be a multicast router for said host node;
the method comprising:
upon receiving by a given router node a multicast packet or a request for subscription to a multicast group from a given host node, said router node transmits to the other router nodes of the LLN network within its direct radio range an announcement message including its status with respect to the host node and the address of said host node; and
upon receiving said announcement message, each of said other router nodes compares its current status with respect to said host node with the status indicated in the announcement message, and configures its status according to said comparison so that a single node within direct radio range of said router node from among the nodes of the LLN network transmits to the root node an MER_Request configuration request as a multicast router for the data stemming from or intended for said given host node,
upon receiving said request MER_Request, the root node grants the MER status for said router node to the first router node having transmitted a request MER_Request.

23. The method according to claim 22, further comprising storing in memory in each router node a second association table of routing information in the following fields:
field <<host address>> intended to contain the address of the host node;
an optional field <<host type>> intended to contain the type of said host node from among one of the two following types, source or receiver;
an optional field <<multicast IP address>> intended to contain the address of a multicast group to which belongs the host node;
a field <<status>> intended to contain the status of the router node with respect to said host node, and which may assume one of the four following values: CANDIDAT_MER, PENDING, MER, and NON_MER;
a field <<Lifetime_table_entry>> intended to contain a lifetime of the status of the router node with respect to said host node;
a field <<Lifetime_status>> intended to contain a wait time of a router in a CANDIDAT_MER mode before passing to the PENDING mode and sending an MER_Request message to the root node.

24. The method according to claim 23, wherein, when a router node receives said announcement message, it first checks in said second association table whether one of its entries corresponds to the fields: host address, [host type], and [multicast IP address] of the received announcement message, and, if no entry corresponds to the fields: host address, [host type], and [multicast IP address] of the received announcement message, said router node ignores the received announcement message.

25. The method according to claim 23, wherein, when a router node receives said announcement message, it first checks in said second association table if one of its entries corresponds to the fields: host address, [host type], and [multicast IP address], of the received announcement message and, if an entry corresponds to the fields: host address, [host type], and [multicast IP address], of the received announcement message, then,
if the announcement message contains a status CANDIDAT_MER and if the entry found in said second association table has a status CANDIDAT_MER, the router node compares its address with that of the router node transmitter of the announcement message and keeps its status CANDIDAT_MER if its address is less than that of the router node transmitter of the announcement message, or sets the status associated with the entry found to NON_MER if its address is greater than the address of the router node transmitter of the announcement message;
if the announcement message contains a status CANDIDAT_MER and if an entry in said second association table has a status PENDING, a status NON_MER, or a status MER for said router node with respect to the identified router node in the announcement message, the latter ignores the received announcement message;
if the announcement message contains a status MER and if an entry in said second association table has a status NON_MER, said router node replaces the value of the lifetime_table_entry field associated with the entry found with the one indicated in the received message so as to synchronize the value of the field [lifetime_table_entry] at all the router nodes having the entry found;
if the announcement message contains a status MER and if an entry in said second association table has a status CANDIDAT_MER or a status PENDING, said router node replaces the value of the lifetime_table_entry field associated with the entry found with the one indicated in the received message and changes the status of the entry to NON_MER;
if the announcement message contains a status NON_MER, then,
if an entry of said second association table has a status MER, said router node ignores the received message,
if an entry of said second association table has a status NON_MER, said router node replaces the value of the lifetime_table_entry field associated with the entry found with the one indicated in the received message,
if an entry of said second association table has a status CANDIDAT_MER or a status PENDING, said router node replaces the value of the lifetime_table_entry field associated with the entry found with the one indicated in the received message and changes the status of the entry to NON_MER.

26. The method according to claim 24, wherein, when a router node receives a request for subscription to a multicast group of router nodes of the receiver type, said router node consults said second association table to check whether it has already received a same subscription request, and,
if this is the case, the subscription request message is ignored by said router node,
otherwise, the router node generates a new entry in its second association table containing the fields: host IP address, [host type=receiver], [multicast IP address] inferred from the received subscription request, sets its status corresponding to the added entry to CANDIDAT_MER, associates this status with a lifetime_status field and with a lifetime_table_entry field each containing a non-zero value, and then, broadcasts, in a multicast mode with a local range, an announcement message including the status CANDIDAT_MER as well as the fields: host IP address, [host type=receiver], [multicast IP address].

27. The method according to claim 26, wherein, upon receiving a response message MER_Reply transmitted by the root node and including a status NON_MER, the router node having received the request for subscription to a multicast group checks whether there exists in said second association table router nodes concerned by the received response message MER_Reply, and, if this is the case, sets its status with respect to the relevant router nodes to NON_MER, and replaces the value of the lifetime_table_entry field with the one indicated in the received message MER_Reply.

28. The method according to claim 26, wherein, upon receiving by a router node, a response message MER_Reply transmitted by the root node and including a status MER, said router node:
checks whether there exists in the second association table a host node concerned by the received MER_Reply,
if yes, said router node sets its status with respect to the relevant host node to MER, and,
replaces the lifetime of its status with respect to the relevant host node with the one indicated in the received message MER_Reply;
establishes a multicast branch going towards said host node, and,
broadcasts, in multicast mode with a local range, an announcement message including the status MER as well as the fields: [host IP address], [host type=receiver], [multicast IP address] so as to allow the router nodes within direct radio range and having an entry corresponding to the fields: host IP address, [host type=receiver] and [multicast IP address] marked with the NON_MER or PENDING status to update the value of the field [lifetime_table_entry] of this entry on the basis of the one which is indicated in the announcement message.

29. The method according to claim 22, wherein, the announcement transmitted by the router node is implemented through a message of DIO type of RPL protocol (DODAG Information Object).

30. The method according to claim 24, wherein, when a router node receives a multicast data packet transmitted by a router node of the source type, it consults its second association table in order to check whether one of its entries corresponds to the fields: [host address], [host type=source], and [multicast IP address] inferred from the received multicast packet, and,
if this is the case, the router node checks the status associated with the entry found,
if the status associated with the entry found is CANDIDAT_MER, the router node broadcasts in multicast mode with a local range an announcement message comprising the status CANDIDAT_MER as well as the fields: [host IP address], [host type=source], [multicast IP address],
if the status associated with the entry found is PENDING, the router node stores in memory the received multicast packet,
if the status associated with the entry found is MER, the router node transfers the received packet into the multicast tree,
if the status associated with the entry found is NON_MER, the router node ignores the received multicast packet;
if this is not the case, the router node:
generates a new entry in its second association table containing the fields: [host IP address], [host type=source], [multicast IP address] inferred from the received multicast packet,
sets its status corresponding to the added entry to CANDIDAT_MER, and,
associates this status with a field [lifetime_status] and with a field [lifetime_table_entry] each containing a non-zero value, and then,
broadcasts in multicast mode with a local range, an announcement message including the status CANDIDAT_MER as well as the fields: [host IP address], [host type=receiver], [multicast IP address].

31. The method according to claim 30, wherein, upon receiving by a router node a response message MER_Reply transmitted by the root node and including a status NON_MER, said router node:
checks whether there exists in the second association table a host node concerned by the received response message MER_Reply;
if yes, the router node sets its status with respect to the relevant host node to NON_MER, and,
replaces the value of the field [lifetime_table_entry] with the one indicated in the received message MER_Reply,
suppresses from its memory the whole multicast data packet associated with said entry.

32. The method according to claim 30, wherein, upon receiving by a router node a response message MER_Reply transmitted by the root node and including a status MER, said router node:
checks whether there exists in the second association table a host node concerned by the received MER_Reply,
if yes, said router node sets its status with respect to the relevant host node to MER, and,
replaces the lifetime of its status with respect to the relevant host node with the one indicated in the received message MER_Reply, and,
broadcasts in multicast mode with a local range, an announcement message including the status MER as well as the fields: [host IP address], [host type=receiver], [multicast IP address] so as to allow the router nodes within direct radio range and having an entry corresponding to the fields: [host IP address], [host type=source] and [multicast IP address] marked with the status NON_MER to update the value of the field [lifetime_table_entry] of this entry on the basis of the one which is indicated in the announcement message.

33. The method according to claim 30, wherein, if at a given router node the status associated with a given entry corresponding to the fields: [host IP address], [host type=source], [multicast IP address] is CANDIDAT_MER and if the time period indicated in the field [lifetime_status] associated with this entry expires, said router node passes to the status PENDING for said entry and transmits to the root node an MER_Request message.

34. The method according to claim 30, wherein, if at a given router node, the value of the field [lifetime_table_entry] associated with a given entry corresponding to the fields: [host IP address], [host type=source], [multicast IP address] inferred from the received data packet expires, said router suppresses said entry from its association table.

35. A method for preselecting a subset of router nodes in an LLN (Lower power and Lossy channel Network) network from a set of nodes which may act as routers for data packets exchanged between a plurality of host nodes, said LLN network including a root node responsible for managing a first table containing a list of router nodes allowed to transfer multicast packets from the LLN network to a given router node or from a given router node to the LLN network, each router node having a status from among one of the following statuses:
Candidat_Mer (Multicast Edge Router), indicating that said router node is a candidate for acting as a single router for a given host node;
NON_Candidat_Mer (Multicast Edge Router), indicating that said router node is not a candidate for acting as a single router for a given host node;
the method comprising:
each router node transmits to the other router nodes of the LLN network within its direct radio range an announcement message including a piece of information having a value on the basis of which will be conducted the configuration of the other router nodes as CANDIDAT_MER or NON_CANDIDAT_MER, and, upon receiving said announcement message, each of said other router nodes compares the value of its own information with that contained in the announcement message, and, if the value of the information contained in the announcement message is less than the value of the information of the router node having received said announcement message, then the latter puts itself in the NON_CANDIDAT_MER state, otherwise, the router node having received said announcement message remains in the CANDIDAT_MER_state.

36. The method according to claim 35, wherein, each router node having a status NON_CANDIDAT MER includes a transfer table with which it may manage exchanges of the multicast packets between a router node and a host node, said transfer table including the following fields:
the field <<host address>> intended to contain the address of the host node;
the optional field [host type] intended to contain the type of said host node from among one of the two following types, source or receiver;
the optional field [multicast IP address] intended to contain the address of a multicast group to which the host node belongs;
the field <<MAC_x address>>: intended to contain the MAC address of the node from which has received the multicast packet or the MLD report message;
the field Lifetime_table_entry intended to contain a lifetime of the entry associated with the host node in said transfer table.

37. The method according to claim 35, wherein, each router node includes a table of announcements containing the neighboring routers from which it has received an announcement message, so that every time a NON_CANDIDAT_MER router node receives an announcement message from a new router node which is not listed in its table of announcements, said NON_CANDIDAT_MER router adds the MAC address of said new router node into said table of announcements, compares the MAC address of the new router node with the MAC address of the current CANDIDAT_MER router node indicated in its table of announcements, and if the IP address of the new router node is less than that of the current CANDIDAT_MER router node, said NON_CANDIDAT_MER router node considers that it is the new router node which is a new CANDIDAT_MER and updates its table of announcements accordingly.

38. The method according to claim 37, wherein, when a router node receives a request for subscription to a multicast group of host nodes of the receiver type, it consults its second association table to check whether it has already received a same subscription request, and
if this is the case, the request is ignored,
otherwise, the router node:
generates a new entry in its transfer table containing the fields: host IP address, [host type=receiver], [multicast IP address] inferred from the received subscription request,
associates with this entry the field <<MAC_x address>> which contains the MAC address of the node from which was received the subscription request,
associates with this entry a field lifetime_table_entry containing a non-zero value; and
if said router node is in the CANDIDAT_MER state, it stores in memory the message received in the subscription request and, translates this message into an MER_Request message, and then transmits said MER_Request message to the root node;
if said router node is in the NON_CANDIDAT_MER state, it transfers said message to the CANDIDAT_MER node indicated in his table of announcements.

39. The method according to claim 37, wherein, when a router node receives a multicast data packet transmitted by a host node of the source type, it consults its transfer table to check whether one of its entries corresponds to the fields: [host address], [host type=source], and [multicast IP address] inferred from the received multicast packet, and
if this is not the case, the router node:
generates a new entry in its transfer table containing the fields: host IP address, [host type=source], [multicast IP address] inferred from the received multicast packet,
associates with the added entry a field <<MAC_x address>> containing the MAC address of the node from which was received the multicast packet and a field lifetime_table_entry containing a non-zero value; and
if said router node is of the CANDIDAT_MER type, it stores in memory the received data packet, and transmits an MER_Request message to the root node;
if said router node is of the NON_CANDIDAT_MER type, it transfers the received multicast packet to its CANDIDAT_MER router indicated in its table of announcements.

40. A device for preselecting a router in a LLN (Lower power and Lossy channel Network) network from a plurality of nodes which may act as routers of data packets exchanged between a plurality of host nodes, said LLN network including a root node responsible for managing a first table intended to store in memory for each router node a status from among one of the following statuses:
Candidat_Mer (Multicast Edge Router), indicating that said router node is a candidate for acting as a single router for a given host node;
PENDING, indicating that the router node is waiting to be selected as a single router for said host node,
MER, indicating that said router node is configured as a single router for said host node,
wherein in the device:
said router node is configured to transmit to the other router nodes of the LLN network within direct radio range of said router nodes an announcement message including its status with respect to the host node and the address of said router nodes upon receiving a data packet or a message of the MLD (Multicast Listener Discovery) Report type from a given host node,
each of said other router nodes is configured to compare its current status with respect to said host node with the status indicated in the announcement message, and to configure its status depending on said comparison so that a single node from among the nodes of the LLN network within direct radio range of said router nodes transmits to the root node a configuration request MER_Request as a multicast router for the data from or intended for said given router node, and
the root node is configured to grant the MER status for said router nodes to the first router node having transmitted to it a request MER_Request as a reply to said announcement message.

41. A device for preselecting a subset of router nodes in a LLN (Lower power and Lossy channel Network) network from a set of nodes which may act as routers for data packets exchanged between a plurality of host nodes, said LLN network including a root node responsible for managing a first table intended to store in memory for each router node a status from among one of the following statuses:
Candidat_Mer (Multicast Edge Router), indicating that said router node is a candidate for acting as a single router for a given host node;
NON_Candidat_Mer (Multicast Edge Router), indicating that said router node is not a candidate for acting as a single router for a host node;
wherein in the device:
each router node is configured to transmit to the other router nodes of the LLN network within its direct radio range an announcement message including information having a value on the basis of which will be conducted the configuration of the router nodes as CANDIDAT_MER or NON_CANDIDAT_MER; and
each of said other router nodes is configured to compare the value of its own information with that contained in the announcement message, so that if the value of the information contained in the announcement message is less than the value of the information of the router node having received said announcement message, then the latter puts itself in the NON_CANDIDAT_MER state, otherwise it remains in the CANDIDAT_MER state.

42. A computer program stored in memory on a non-transitory computer readable recording medium including instructions for carrying out the method according to claim 22 when executed on a computer.
